(19) United States
(12) Patent Application Publication
(10) Pub. No.: US 2012/0173327 A1
(43) Pub. Date: Jul. 5, 2012

(54) PROMOTING, DELIVERING AND SELLING INFORMATION TO INTRANET USERS

(75) Inventors: Blaine H. Dolph, Western Springs, IL (US); Christopher J. Gansen, Chicago, IL (US)

(73) Assignee: INTERNATIONAL BUSINESS MACHINES CORPORATION, Armonk, NY (US)

(21) Appl. No.: 12/983,433

(22) Filed: Jan. 3, 2011

(51) Int. Cl. G06Q 30/00

(52) U.S. Cl. 705/14.46; 705/14.66; 705/14.69; 705/14.52

(57) ABSTRACT

A method and system for managing targeted placement of content on an intranet. An ad server within the intranet collects statistics summarizing anonymized intranet user attributes and securely provides the statistics to a marketplace computer outside the intranet. The marketplace computer receives an ad, parameter values, and a bid from a publisher outside the intranet. The bid is based on the statistics. The ad server receives the ad, parameter values and bid and determines the ad is acceptable for placement on an intranet page. The ad server identifies intranet users to view the ad by matching the parameter values to user attributes retrieved from intranet data repositories that are not accessible to the publisher. The ad is placed on the intranet page displayed to the identified users. Clicks and/or impressions data associated with the ad are recorded and presented to the publisher.

### FIELD OF THE INVENTION

The present invention relates to a data processing method and system for managing content on intranets, and more particularly to presenting external content to targeted intranet users.

### BACKGROUND

By definition, intranets are non-public networks that are largely inaccessible to third parties. External content providers (i.e., content providers that are external to intranets) cannot place their content on intranets without significant investments in time, partnerships, and technical problem solving. Further, known techniques for placing external content on intranets are limited and imprecise because data sources stored in intranets are protected and inaccessible to external parties. Still further, known Internet-based targeted ad placement services (e.g., AdSense® online advertising service offered by Google, Inc. located in Mountain View, Calif.) utilize software-based crawlers to index website content, but the crawlers cannot access the protected content and data sources within an intranet. Thus, there exists a need to overcome at least one of the preceding deficiencies and limitations of the related art.

### BRIEF SUMMARY

In first embodiments, the present invention provides a method of managing a targeted placement of external content on an intranet. The method comprises:

an internal computer system receiving content of an ad and parameter values previously received by an external computer system in a request from a publisher computer system to place the ad in an intranet owned by an enterprise, wherein the internal computer system resides inside the intranet, and wherein the external computer system and the publisher computer system reside outside the intranet;

the internal computer system identifying one or more users of a plurality of users of the intranet by matching the received parameter values to attributes of the one or more users, wherein the attributes and are retrieved from data repositories that are included in the intranet and that are not accessible by the publisher computer system; and

the internal computer system targeting the ad to the one or more identified users by placing the ad on a page of the intranet and initiating a display of the ad to the one or more identified users based on the attributes of the one more users matching the received parameter values, and not based on an any action performed by the one or more users in the intranet.

In second embodiments, the present invention provides a method of managing a targeted placement of external content on an intranet. The method comprises:

an external computer system receiving content of an ad and parameter values in a request from a publisher computer system to place an ad in an intranet owned by an enterprise, wherein the external computer system and the publisher computer system reside outside the intranet;

the external computer system receiving a bid from the publisher computer system, wherein the bid is an amount of money offered to have the ad placed on the intranet and displayed to one or more users of the intranet; and

the external computer system sending the content of the ad, the parameter values and the bid to an internal computer system that is inside the intranet, wherein a result of the sending the content of the ad, the parameter values and the bid is a determination that the ad is permitted to be placed on the intranet, an identification of the one or more users of the intranet based on attributes of the one or more users matching the parameter values, and a placement of the ad on a page of the intranet based on the attributes matching the parameter values.

A system, program product and a process for supporting computing infrastructure, where the process provides at least one support service, are also described herein, where the system, program product and process for supporting computing infrastructure correspond to the above-summarized method.

Embodiments of the present invention provide a technique for managing and facilitating targeted placement and usage of third party content on intranets by allowing secure, anonymous exposure of intranet data sources.

### BRIEF DESCRIPTION OF THE DRAWINGS

FIG. 1 is a block diagram of a system for managing a targeted placement of external content on an intranet, in accordance with embodiments of the present invention.

FIGS. 2A-2B depict a flowchart of a process of managing a targeted placement of external content on an intranet, where the process is implemented by the system of FIG. 1, in accordance with embodiments of the present invention.

FIG. 3 is a block diagram of a computer system that is included in the system of FIG. 1 and that implements the process of FIGS. 2A-2B, in accordance with embodiments of the present invention.

### DETAILED DESCRIPTION

### Overview

Embodiments of the present invention may provide a technique to manage and facilitate the placement of external content on intranets, where external content is defined as content supplied by a third party who is external to the intranets. In one embodiment, the external content is a public advertisement. Further, embodiments of the present invention may securely integrate data sources (a.k.a. data stores or data repositories) in intranets with the placement of external content on intranets, and may track and manage the usage of external content on intranets. An enterprise's data stores (e.g., directories including the enterprise's human resources data, skills databases, databases that include users' assignments within the enterprise, databases that include user-generated content, etc.) include profile data about users (e.g., persons employed by the enterprise) of the enterprise's intranet. The profile data included in the data stores may include the users' skills, geographic locations, roles (e.g., job title or post of employment within the enterprise), special interests, and any classifications that describe the user. The data in the data stores includes valuable intellectual property of the enterprise and is therefore inaccessible to third parties in known systems. In embodiments of the present invention, however, anonymized data from the aforementioned data stores is securely exposed in order to deliver highly targeted external content to particular intranet users. The targeting of external content to particular users of an intranet is provided by embodiments of the present invention without requiring that any entity external to the intranet (e.g., person, hardware or software program external to the intranet) has access to the intranet, any page of enterprise content provided by the intranet, or any data source stored within the intranet. In particular, the targeting of external content described herein does not require the use of software-based indexing crawlers that index site content in order to deliver targeted ads in known targeted ad techniques.

### System for Managing Targeted Placement of External Content on an Intranet

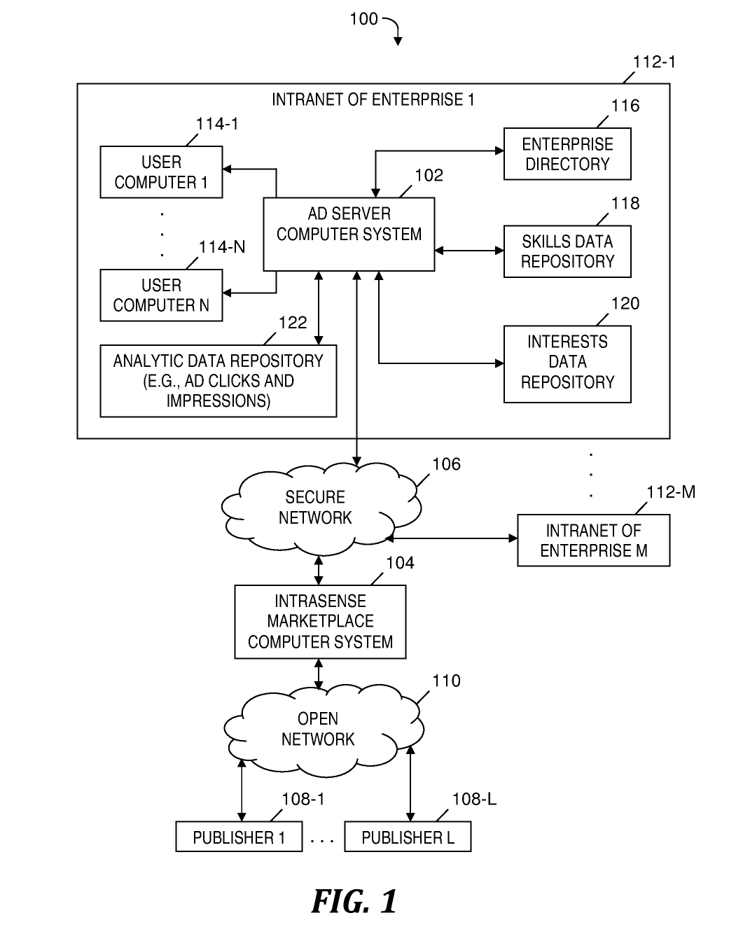

FIG. 1 is a block diagram of a system for managing a targeted placement of external content on an intranet, in accordance with embodiments of the present invention. System 100 includes an ad server computer system 102 and an Intrasense Marketplace computer system 104 that exchange data with each other via a secure network 106. Hereinafter, for simplicity, ad server computer system 102 is referred to as ad server 102 and Intrasense Marketplace computer system 104 is referred to as Intrasense Marketplace 104.

System 100 also includes computer systems utilized by L content publishers 108-1 . . . 108-L, where L is a positive integer. Publishers 108-1 . . . 108-L utilize their computer systems to exchange data with Intrasense Marketplace 104 via an open network 110 (e.g., the Internet). Each publisher 108-1 . . . 108-L may be either a user internal to an intranet 112-1 or an external content provider (i.e., a content provider that is external to intranet 112-1). Intrasense Marketplace 104 may be implemented as a standalone product or a hosted solution whose access is sold to the publishers.

Ad server 102 is included in intranet 112-1, which is owned by enterprise 1. Intranets 112-1 . . . 112-M of enterprises 1 . . . M, where M is a positive integer, are included in system 100 and each include an ad server computer system that is or has the functionality of ad server 102 and that exchanges data with Intrasense Marketplace 104 via secure network 106. Data transfer between Intrasense Marketplace 104 and any of the intranets 112-1 . . . 112-M via secure network 106 may be based on a known secure communication technique (e.g., VPN-based communication), such as employing cryptographic tunneling protocols, sender authentication, and data transfer encapsulation to keep the data transfers inaccessible to other devices, block intercepts and prevent packet sniffing and identity spoofing.

Embodiments of the present invention include a system for delivering ads targeted to particular users of intranet 112-1, where the system includes ad server 102 residing within intranet 112-1 and Intrasense Marketplace 104 residing outside intranet 112-1.

A publisher 108-1 accesses a website provided by Intrasense Marketplace 104, which resides outside intranets 112-1 . . . 112-M, and submits a piece of information (e.g., an advertisement (a.k.a. ad)) via the website, where the piece of information may potentially be pushed out to appropriate user(s) of one or more intranets 112-1 . . . 112-M. The piece of information submitted may be an image, text, a multimedia format, or a combination thereof. For pieces of information in a non-text media format, Intrasense Marketplace 104 may specify predefined dimensions (e.g., generally accepted ad dimensions).

Within intranet 112-1, ad server 102 communicates with N computers (i.e., user computer 114-1 . . . 114-N) utilized by N users of intranet 112-1, where N is a positive integer. In one embodiment, the N users are employed by enterprise 1. Ad server 102 may push an ad or other piece of publisher-submitted information to user(s) 114-1 . . . 114-N based on whether attributes of the user(s) match parameters submitted by the publisher who submitted the ad or other piece of information.

Intranet 112-1 also includes an enterprise directory 116 (i.e., a directory of information about persons employed by enterprise 1), a skills data repository 118 that stores skills of enterprise 1 personnel, and an interests data repository 120 that stores interests of enterprise 1 personnel. The aforementioned attributes that the ad server 102 attempts to match to the submitted parameters are stored in enterprise directory 116, skills data repository 118, interests data repository 120, and/or other data repositories (not shown).

Further, intranet 112-1 includes an analytic data repository 122 that stores statistics that ad server computer system 102 collects about the targeted ads placed on intranet 112-1. The statistics included in repository 122 may include the number of clicks and/or the number of impressions for each targeted ad placed on intranet 112-1.

System 100 allows the targeting of ads to users of intranet 112-1 without having to index pages of the intranet through a firewall. In one embodiment, the pages of the intranet are not permitted to be indexed because the pages include information that is sensitive to the enterprise that owns the intranet.

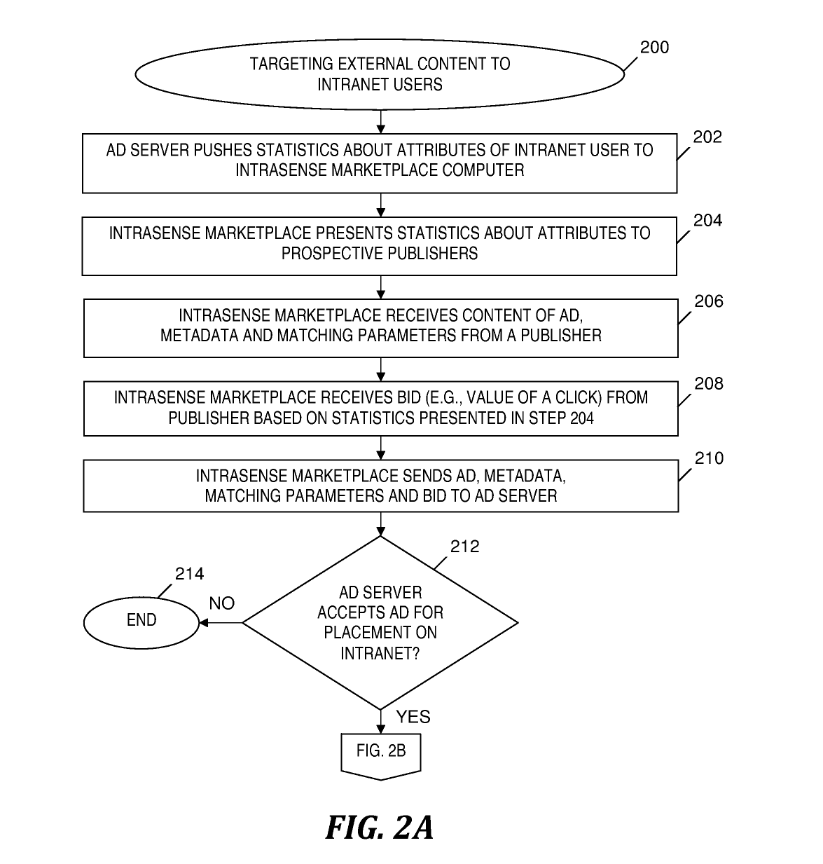

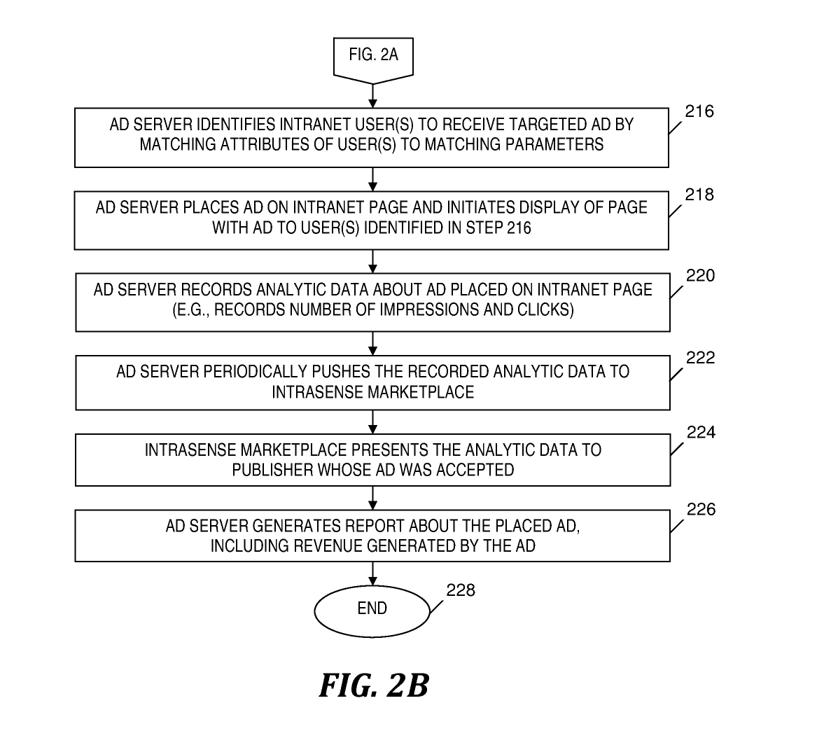

Further details about the functionality of the components of system 100 are presented below relative to FIGS. 2A-2B.

### Process of Managing Targeted Placement of External Content on an Intranet

FIGS. 2A-2B depict a flowchart of a process of managing a targeted placement of external content on an intranet, where the process is implemented by the system of FIG. 1, in accordance with embodiments of the present invention. The process of managing a targeted placement of external content on an intranet starts at step 200. In this section, the functionality of Intrasense Marketplace 104 (see FIG. 1) may be implemented by a website provided by Intrasense Marketplace 104 (see FIG. 1).

In step 202, ad server 102 (see FIG. 1) pushes statistics about attributes of user(s) of intranet 112-1 (see FIG. 1) to Intrasense Marketplace 104 (see FIG. 1). For example, Intrasense Marketplace 104 (see FIG. 1) receives a first number of managers that can be targeted by placing an ad in intranet 112-1 (see FIG. 1) owned by Enterprise 1 and a second number of managers that can be targeted by placing the same ad in intranet 112-M (see FIG. 1) owned by Enterprise M, and then presents these numbers of managers to the publishers 108-1 . . . 108-L (see FIG. 1) (see step 204 below).

In step 204, Intrasense Marketplace 104 (see FIG. 1) generates a report, initiates a display of, or otherwise presents the statistics about the attributes of user(s) of intranet 112-1 (see FIG. 1) to prospective publishers 108-1 . . . 108-L (see FIG. 1). The aforementioned statistics may include numbers of users of intranet 112-1 (see FIG. 1) that have each of the aforementioned attributes. For example, the statistics may include the number of users of intranet 112-1 (see FIG. 1) who are managers, the number of users of the intranet who are located in Chicago, Ill., and the number of users of the intranet who have negotiation skills.

In step 206, Intrasense Marketplace 104 (see FIG. 1) receives the content of an ad, metadata associated with the ad, and matching parameters from publisher 108-1 (see FIG. 1). Although the process of FIGS. 2A-2B describes the placement of an ad, the present invention is not limited to advertisements; other embodiments may place any kind of information that is targeted to particular intranet users.

In step 208, Intrasense Marketplace 104 (see FIG. 1) receives a bid from publisher 108-1 (see FIG. 1), where the bid is based on the statistics presented in step 204. The bid received in step 208 may be the amount of money the publisher 108-1 (see FIG. 1) is offering to pay for a targeted placement of the ad whose content was received in step 206, and may include the amount of money the publisher is offering to pay per click on the ad or per impression of the ad on pages presented by the intranet. The aforementioned targeted placement of the ad is defined as a placement of the ad on page(s) of an intranet so that the ad is presented to only the user(s) of the intranet whose attributes (i.e., user profile data) match a set of matching parameters previously received from a publisher of the ad (e.g., the matching parameters received in step 206).

The publisher's bid may be based, for example, on the number of users of intranet 112-1 (see FIG. 1) that have attributes that match the matching parameters received in step 206, where the number of users is included in the statistics presented in step 204.

The publisher may submit multiple bids for the placement of the ad, where some or all of the bids may be different from one another, and where each bid is for the placement of the ad on a corresponding intranet of the multiple intranets 112-1 . . . 112-M (see FIG. 1).

If the publisher is an internal intranet user (e.g., a person employed by Enterprise XYZ who wants to push out information to others employed by Enterprise XYZ), then the publisher is not required to bid an amount of money and step 208 is skipped (or the amount of the bid in step 208 is zero). Examples of information that an internal intranet user may want to push out through the ad placement system described herein include: an announcement that promotes the user or the user's project or blog, or a call for other enterprise personnel to participate in an internal conference. In an alternate embodiment, the internal intranet user who is a publisher may agree to an ad exchange between intranet pages as a substitute for offering a bid in step 208. In another alternate embodiment, internal intranet users are allocated a predetermined number of non-monetary bidding “points” (i.e., non-monetary units to be used for bidding on targeted ad placement) and step 208 is changed to Intrasense Marketplace 104 (see FIG. 1) receiving a bid from an internal intranet user who is a publisher, where the bid is a number of the user's allocated bidding points.

In step 210, Intrasense Marketplace 104 (see FIG. 1) sends the ad content (i.e., matching inventory), metadata and matching parameters received in step 206, and the bid received in step 208 to ad server 102 (see FIG. 1). In one embodiment, the metadata may include a time frame in which the ad is to be active and key words that describe the content of the ad. In one embodiment, the matching parameters include values that specify the attributes of users who the publisher 108-1 (see FIG. 1) wants to target by the placement of the ad in intranet 112-1 (see FIG. 1). The publisher 108-1 (see FIG. 1) may specify a range of matching parameters, from selecting an option to display the ad on randomly selected pages in intranet 112-1 (see FIG. 1) to selecting a precisely targeted (a.k.a. hyper targeted) ad by specifying matching parameter values to match to multiple user attributes. The publisher may select matching parameter values to match to user attributes selected from the following: a user's employer (e.g., name(s) or type(s) of business of the enterprise that employs the user), a user's role in the enterprise (e.g., manager, developer, or vice-president), the user's geographic location, the user's set of skills (e.g., knowledge of Java®, negotiations and/or Information Architecture), the user's interests (e.g., interests retrieved from the user's profile posts in Lotus® Connections™ social software offered by International Business Corporation located in Armonk, N.Y.).

An example of a hyper targeted ad placement is: Corporation XYZ requests an ad to notify all managers to sign document ABC by date MMDDYY. By a lookup of data in enterprise directory 116 (see FIG. 1), ad server 102 (see FIG. 1) identifies which users are managers and then looks up the status of document ABC corresponding to the identified managers to determine which of the managers have not yet signed document ABC. Subsequent to the aforementioned lookups, ad server 102 (see FIG. 1) places the hyper targeted ad on intranet pages being viewed only by managers who have not yet signed document ABC. The ad would not be displayed to managers who have already signed document ABC.

By sending the ad content, metadata and matching parameters to the ad server in step 210, the ad may be served completely within the intranet 112-1 (see FIG. 1), thereby targeting the placement of the ad on the intranet while avoiding the need to send sensitive information such as the user profile data from the enterprise's data sources to third parties external to the intranet.

If ad server 102 (see FIG. 1) determines in step 212 that the ad should not be placed on intranet 112-1 (see FIG. 1), then the No branch of step 212 is taken and the process of managing a targeted placement of external content on an intranet ends at step 214 with the ad not being placed in an intranet. Ad server 102 (see FIG. 1) may filter out a proposed ad in the No branch of step 212 based on the content of the ad being not authorized by the enterprise that owns intranet 112-1 (see FIG. 1). For example, enterprise 1 (i.e., the owner of intranet 112-1 in FIG. 1) may not authorize the placement of any ads that solicit enterprise 1 personnel to apply for a job external to enterprise 1, and therefore step 212 will filter out such ads. Ad server 102 (see FIG. 1) may also filter out proposed ads if the bid received in step 208 is less than a threshold amount that is predetermined by the enterprise that owns intranet 112-1 (see FIG. 1).

If ad server 102 (see FIG. 1) determines in step 212 that the ad is acceptable based on predetermined criteria provided by the enterprise that owns intranet 112-1 (see FIG. 1), then the Yes branch of step 212 is taken and the process continues with step 216 in FIG. 2B.

In step 216, ad server 102 (see FIG. 1) identifies user(s) of intranet 112-1 (see FIG. 1) to receive the targeted placement of the ad by matching attributes of the user(s) to the matching parameters received in step 206 (see FIG. 2A). Ad server 102 (see FIG. 1) may also match the content of the ad with the requirements of a page of intranet 112-1 (see FIG. 1) on which the ad is to be displayed. In one embodiment, the ad server 102 (see FIG. 1) determines a page of intranet 112-1 (see FIG. 1) on which to display the ad based on a match between one or more key words included in the metadata sent in step 210 (see FIG. 2A) and one or more key words that are included in or that describe the content of the page of the intranet.

In step 218, ad server 102 (see FIG. 1) places the ad on page(s) of intranet 112-1 (see FIG. 1) and initiates a display of the page(s) with the ad to the user(s) identified in step 216. In order for the ad to be successfully placed on a page of the intranet, program code (not shown in FIG. 1) that allows the display of the ad must be already embedded in the page.

In step 220, ad server 102 (see FIG. 1) records analytic data about the ad placed in step 218 and stores the analytic data in repository 122 (see FIG. 1). In one embodiment, the analytic data recorded in step 220 includes a count of the number of clicks, a count of the number of impressions, an anonymized profile of users who clicked on the ad, and/or an anonymized profile of users who viewed the ad. The number of clicks is the number of times users of intranet 112-1 (see FIG. 1) click on a hyperlink in the ad to obtain more information. The number of impressions is the number of times the ad is displayed on a page of the intranet 112-1 (see FIG. 1), where the page is viewable by a targeted user of the intranet.

In step 222, ad server 102 (see FIG. 1) periodically pushes the analytic data recorded in step 220 to Intrasense Marketplace 104 (see FIG. 1).

In step 224, Intrasense Marketplace 104 (see FIG. 1) generates a report, initiates a display of, or otherwise presents the analytic data pushed in step 222 to publisher 108-1 (see FIG. 1) (i.e., the publisher whose ad was accepted by the Yes branch of step 212 in FIG. 2A).

In step 226, ad server 102 (see FIG. 1) generates a report about the ad placed in step 218, including the revenue generated by the ad for the enterprise that owns intranet 112-1 (see FIG. 1). The process of FIGS. 2A-2B ends at step 228. An enterprise that includes the ad server 102 (see FIG. 1) in its intranet 112-1 (see FIG. 1) is authorized to connect to Intrasense Marketplace 104 (see FIG. 1) by login and view the report about the ad and the revenue generated by the ad.

The process of FIGS. 2A-2B may be repeated one or more times to target additional ad(s) to the users of intranet 112-1 (see FIG. 1) and/or place targeted ads in pages of additional intranets (e.g., intranet 112-M in FIG. 1). The same ad may be authorized for placement in one intranet in step 212 (see FIG. 2A), but not authorized for placement in another intranet in a subsequent performance of the process of FIGS. 2A-2B. For example, Intranets 1 and 2 are owned by Enterprises 1 and 2, respectively, and the content of Ad ABC may be authorized by Enterprise 1 to be placed on a page of Intranet 1, but not authorized by Enterprise 2 to be placed on a page of Intranet 2.

Furthermore, if profile information for a user changes over time, then the same user may be targeted in one performance of the process of FIGS. 2A-2B, but not targeted in another performance of the process of FIGS. 2A-2B. For example, a publisher makes two requests at two different times (i.e., Time T1 and Time T2) to place the same ad with the same parameter values; i.e., the first and second requests are for an ad for Business XYZ located in city ABC to be targeted to intranet users who are located in city ABC. At Time T1, User U1 is located in city ABC and therefore the process of FIGS. 2A-2B identifies User U1 as a user who is targeted to view the ad for Business XYZ (see step 216 in FIG. 2B) because the user attribute that indicates User U1 is located in city ABC matches the parameter value that indicates that targeted users must be located in city ABC. After the ad expires after Time T1 (but before Time T2), User U1 relocates to city DEF and an intranet data repository of user attributes is updated to indicate the new location of User U1. At time T2, User U1 is located in city DEF and therefore, the process of FIGS. 2A-2B does not identify User U1 as a user who is targeted to view the ad for Business XYZ, because the updated attribute of User U1 being in city DEF does not match the parameter value that specifies that targeted users must be located in city ABC.

### Computer System

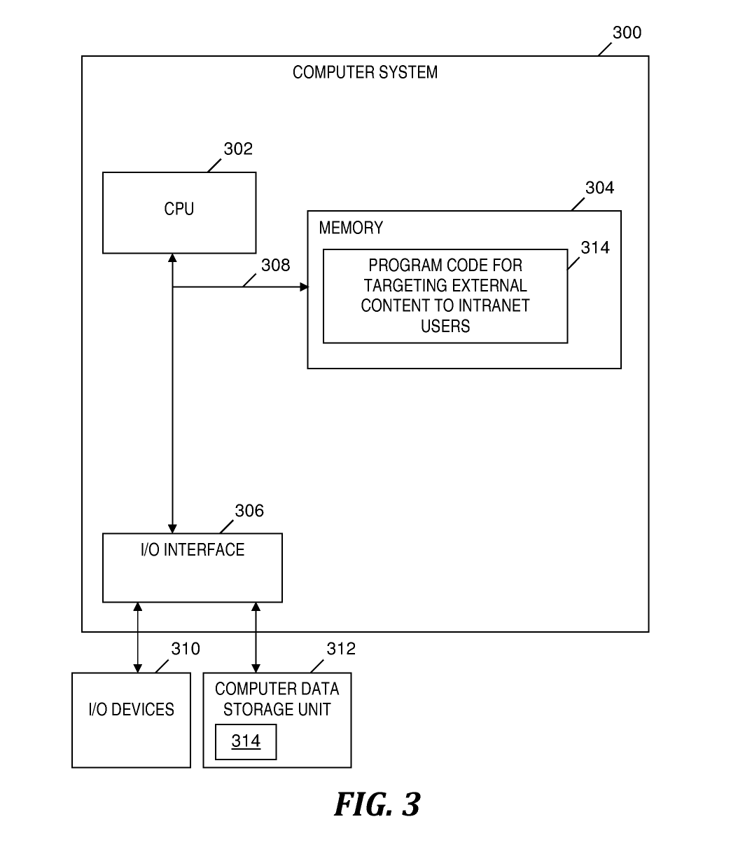

FIG. 3 is a block diagram of a computer system that is included in the system of FIG. 1 and that implements the process of FIGS. 2A-2B, in accordance with embodiments of the present invention. Computer system 300 generally comprises a central processing unit (CPU) 302, a memory 304, an input/output (I/O) interface 306, and a bus 308. Further, computer system 300 is coupled to I/O devices 310 and a computer data storage unit 312. CPU 302 performs computation and control functions of computer system 300, including carrying out instructions included in program code 314 to implement a method of targeting external content to intranet users, where the instructions are carried out by CPU 302 via memory 304. CPU 302 may comprise a single processing unit, or be distributed across one or more processing units in one or more locations (e.g., on a client and server).

In one embodiment, computer system 300 may be ad server computer system 102 (see FIG. 1) that carries out instructions included in program code 314 to implement the functionality of the ad server, and another computer system (not shown) analogous to computer system 300 may be Intrasense Marketing computer system 104 (see FIG. 1) that carries out instructions included in other program code (not shown) to implement the functionality of the Intrasense Marketing computer system. In another embodiment, computer system 300 may be Intrasense Marketing computer system 104 (see FIG. 1) that carries out instructions included in program code 314 to implement the functionality of the Intrasense Marketing computer system, and another computer system (not shown) analogous to computer system 300 may be ad server computer system 102 (see FIG. 1) that carries out instructions included in other program code (not shown) to implement the functionality of the ad server.

In one embodiment, computer system 300 may include ad server 102 (see FIG. 1) and Intrasense Marketing 104 (see FIG. 1).

Memory 304 may comprise any known computer-readable storage medium, which is described below. In one embodiment, cache memory elements of memory 304 provide temporary storage of at least some program code (e.g., program code 314) in order to reduce the number of times code must be retrieved from bulk storage while instructions of the program code are carried out. Moreover, similar to CPU 302, memory 304 may reside at a single physical location, comprising one or more types of data storage, or be distributed across a plurality of physical systems in various forms. Further, memory 304 can include data distributed across, for example, a local area network (LAN) or a wide area network (WAN).

I/O interface 306 comprises any system for exchanging information to or from an external source. I/O devices 310 comprise any known type of external device, including a display device (e.g., monitor), keyboard, mouse, printer, speakers, handheld device, facsimile, etc. Bus 308 provides a communication link between each of the components in computer system 300, and may comprise any type of transmission link, including electrical, optical, wireless, etc.

I/O interface 306 also allows computer system 300 to store information (e.g., data or program instructions such as program code 314) on and retrieve the information from computer data storage unit 312 or another computer data storage unit (not shown). Computer data storage unit 312 may comprise any known computer-readable storage medium, which is described below. For example, computer data storage unit 312 may be a non-volatile data storage device, such as a magnetic disk drive (i.e., hard disk drive) or an optical disc drive (e.g., a CD-ROM drive which receives a CD-ROM disk).

Memory 304 and/or storage unit 312 may store computer program code 314 that includes instructions that are carried out by CPU 302 via memory 304 to implement a method of targeting external content to intranet users.

Further, memory 304 may include other systems not shown in FIG. 3, such as an operating system (e.g., Linux) that runs on CPU 302 and provides control of various components within and/or connected to computer system 300.

If computer system 300 is ad server 102 in FIG. 1, storage unit 312 and/or one or more other computer data storage units (not shown) that are coupled to computer system 300 may store enterprise directory 116 (see FIG. 1), skills data repository 118 (see FIG. 1), interests data repository 120 (see FIG. 1), and analytic data repository 122 (see FIG. 1).

As will be appreciated by one skilled in the art, the present invention may be embodied as a system, method or computer program product. Accordingly, an aspect of an embodiment of the present invention may take the form of an entirely hardware aspect, an entirely software aspect (including firmware, resident software, micro-code, etc.) or an aspect combining software and hardware aspects that may all generally be referred to herein as a “module”. Furthermore, an embodiment of the present invention may take the form of a computer program product embodied in one or more computer-readable medium(s) (e.g., memory 304 and/or computer data storage unit 312) having computer-readable program code (e.g., program code 314) embodied or stored thereon.

Any combination of one or more computer-readable mediums (e.g., memory 304 and computer data storage unit 312) may be utilized. The computer readable medium may be a computer-readable signal medium or a computer-readable storage medium. In one embodiment the computer-readable storage medium is a computer-readable storage device or computer-readable storage apparatus. A computer-readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be a tangible medium that can contain or store a program (e.g., program 314) for use by or in connection with a system, apparatus, or device for carrying out instructions.

A computer readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 314) embodied on a computer-readable medium may be transmitted using any appropriate medium, including but not limited to wireless, wireline, optical fiber cable, RF, etc., or any suitable combination of the foregoing.

Computer program code (e.g., program code 314) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 300 or another computer system (not shown) having components analogous to the components of computer system 300 included in FIG. 3. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIGS. 2A-2B) and/or block diagrams of methods, apparatus (systems) (e.g., FIG. 1 and FIG. 3), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 314). These computer program instructions may be provided to a processor (e.g., CPU 302) of a general purpose computer, special purpose computer, or other programmable data processing apparatus to produce a machine, such that the instructions, which are carried out via the processor of the computer or other programmable data processing apparatus, create means for implementing the functions/acts specified in the flowchart and/or block diagram block or blocks.

These computer program instructions may also be stored in a computer-readable medium (e.g., memory 304 or computer data storage unit 312) that can direct a computer (e.g., computer system 300), other programmable data processing apparatus, or other devices to function in a particular manner, such that the instructions (e.g., program 314) stored in the computer-readable medium produce an article of manufacture including instructions which implement the function/act specified in the flowchart and/or block diagram block or blocks.

The computer program instructions may also be loaded onto a computer (e.g., computer system 300), other programmable data processing apparatus, or other devices to cause a series of operational steps to be performed on the computer, other programmable apparatus, or other devices to produce a computer implemented process such that the instructions (e.g., program 314) which are carried out on the computer, other programmable apparatus, or other devices provide processes for implementing the functions/acts specified in the flowchart and/or block diagram block or blocks.

Any of the components of an embodiment of the present invention can be deployed, managed, serviced, etc. by a service provider that offers to deploy or integrate computing infrastructure with respect to targeting external content to intranet users. Thus, an embodiment of the present invention discloses a process for supporting computer infrastructure, wherein the process comprises providing at least one support service for at least one of integrating, hosting, maintaining and deploying computer-readable code (e.g., program code 314) in a computer system (e.g., computer system 300) comprising a processor (e.g., CPU 302), wherein the processor carries out instructions contained in the code causing the computer system to perform a method of targeting external content to intranet users.

In another embodiment, the invention provides a method that performs the process steps of the invention on a subscription, advertising and/or fee basis. That is, a service provider, such as a Solution Integrator, can offer to create, maintain, support, etc. a process of targeting external content to intranet users. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowchart in FIGS. 2A-2B and the block diagrams in FIG. 1 and FIG. 3 illustrate the architecture, functionality, and operation of possible implementations of systems, methods, and computer program products according to various embodiments of the present invention. In this regard, each block in the flowchart or block diagrams may represent a module, segment, or portion of code (e.g., program code 314), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing a targeted placement of external content on an intranet, said method comprising:
an internal computer system receiving content of an ad and parameter values previously received by an external computer system in a request from a publisher computer system to place said ad in an intranet owned by an enterprise, wherein said internal computer system resides inside said intranet, and wherein said external computer system and said publisher computer system reside outside said intranet;
said internal computer system identifying one or more users of a plurality of users of said intranet by matching said received parameter values to attributes of said one or more users, wherein said attributes and are retrieved from data repositories that are included in said intranet and that are not accessible by said publisher computer system; and
said internal computer system targeting said ad to said one or more identified users by placing said ad on a page of said intranet and initiating a display of said ad to said one or more identified users based on said attributes of said one more users matching said received parameter values, and not based on an any action performed by said one or more users in said intranet.

2. The method of claim 1, further comprising:
prior to said receiving said content of said ad, said internal computer system sending statistics to said external computer system, wherein said statistics include counts of how many users of said plurality of users have said attributes; and
said internal computer system receiving a bid from said external computer system, said bid received by said external computer system from said publisher computer system, wherein said bid is an amount of money offered to have said ad placed on said intranet and displayed to said one or more users, and wherein said bid is based on said statistics.

3. The method of claim 1, further comprising:
said internal computer system receiving a bid from said external computer system, said bid received by said external computer system from said publisher computer system, wherein said bid is an amount of money offered to have said ad placed on said intranet and displayed to said one or more users; and
said internal computer system determining that said content of said ad is permitted to be placed on said page of said intranet and determining that said bid exceeds a threshold amount of money predetermined by said enterprise, wherein said placing said ad on said page is performed in response to said determining said content of said ad is permitted.

4. The method of claim 1, further comprising:
said internal computer system receiving metadata associated with said ad, said metadata previously received by said external computer system in said request from said publisher computer system to place said ad in said intranet, wherein said metadata includes one or more key words that describe said contents of said ad; and
said internal computer system determining said ad is to be placed on said page based on said one or more key words matching one or more words that are included in said page or that describe contents of said page.

5. The method of claim 1, further comprising:
said internal computer system recording analytic data that includes a count of how many times a hyperlink in said ad is clicked and/or a count of how many impressions said ad has in pages of said intranet; and
said internal computer system periodically pushing said analytic data to said external computer system, wherein a result of said pushing is said analytic data being sent by said external computer system to said publisher computer system.

6. The method of claim 1, further comprising said internal computer system generating a report that includes an indication of revenue generated by said ad for said enterprise, said revenue based on said bid.

7. The method of claim 1, further comprising:
said internal computer system receiving content of a second ad from said external computer system; and
said internal computer system determining that said content of said second ad is not permitted to be placed on any page of said intranet based on criteria predetermined by said enterprise.

8. The method of claim 1, further comprising:
said internal computer system receiving a second bid from said external computer system, wherein said bid is a second amount of money offered to have a second ad placed on said intranet and displayed to at least one user of said plurality of users of said intranet; and
said internal computer system determining said bid does not exceed a threshold amount of money predetermined by said enterprise; and
said internal computer system determining said second ad is not permitted to be placed on any page of said intranet based on said bid not exceeding said threshold amount.

9. A computer program product, comprising a computer-readable, tangible storage device having a computer readable program code stored therein, said computer readable program code containing instructions that are carried out by a processor of an internal computer system to implement a method of managing a targeted placement of external content on an intranet, said method comprising:
said internal computer system receiving content of an ad and parameter values previously received by an external computer system in a request from a publisher computer system to place said ad in an intranet owned by an enterprise, wherein said internal computer system resides inside said intranet, and wherein said external computer system and said publisher computer system reside outside said intranet;
said internal computer system identifying one or more users of a plurality of users of said intranet by matching said received parameter values to attributes of said one or more users, wherein said attributes and are retrieved from data repositories that are included in said intranet and that are not accessible by said publisher computer system; and
said internal computer system targeting said ad to said one or more identified users by placing said ad on a page of said intranet and initiating a display of said ad to said one or more identified users based on said attributes of said one more users matching said received parameter values, and not based on an any action performed by said one or more users in said intranet.

10. The program product of claim 9, wherein said method further comprises:
prior to said receiving said content of said ad, said internal computer system sending statistics to said external computer system, wherein said statistics include counts of how many users of said plurality of users have said attributes; and
said internal computer system receiving a bid from said external computer system, said bid received by said external computer system from said publisher computer system, wherein said bid is an amount of money offered to have said ad placed on said intranet and displayed to said one or more users, and wherein said bid is based on said statistics.

11. The program product of claim 9, wherein said method further comprises:
said internal computer system receiving a bid from said external computer system, said bid received by said external computer system from said publisher computer system, wherein said bid is an amount of money offered to have said ad placed on said intranet and displayed to said one or more users; and
said internal computer system determining that said content of said ad is permitted to be placed on said page of said intranet and determining that said bid exceeds a threshold amount of money predetermined by said enterprise, wherein said placing said ad on said page is performed in response to said determining said content of said ad is permitted.

12. The program product of claim 9, wherein said method further comprises:
said internal computer system receiving metadata associated with said ad, said metadata previously received by said external computer system in said request from said publisher computer system to place said ad in said intranet, wherein said metadata includes one or more key words that describe said content of said ad; and
said internal computer system determining said ad is to be placed on said page based on said one or more key words matching one or more words that are included in said page or that describe contents of said page.

13. The program product of claim 9, wherein said method further comprises:
said internal computer system recording analytic data that includes a count of how many times a hyperlink in said ad is clicked and/or a count of how many impressions said ad has in pages of said intranet; and
said internal computer system periodically pushing said analytic data to said external computer system, wherein a result of said pushing is said analytic data being sent by said external computer system to said publisher computer system.

14. The program product of claim 9, wherein said method further comprises said internal computer system generating a report that includes an indication of revenue generated by said ad for said enterprise, said revenue based on said bid.

15. The program product of claim 9, wherein said method further comprises:
said internal computer system receiving content of a second ad from said external computer system; and
said internal computer system determining that said content of said second ad is not permitted to be placed on any page of said intranet based on criteria predetermined by said enterprise.

16. The program product of claim 9, wherein said method further comprises:
said internal computer system receiving a second bid from said external computer system, wherein said bid is a second amount of money offered to have a second ad placed on said intranet and displayed to at least one user of said plurality of users of said intranet; and
said internal computer system determining said bid does not exceed a threshold amount of money predetermined by said enterprise; and
said internal computer system determining said second ad is not permitted to be placed on any page of said intranet based on said bid not exceeding said threshold amount.

17. A method of managing a targeted placement of external content on an intranet, said method comprising:
an external computer system receiving content of an ad and parameter values in a request from a publisher computer system to place an ad in an intranet owned by an enterprise, wherein said external computer system and said publisher computer system reside outside said intranet;
said external computer system receiving a bid from said publisher computer system, wherein said bid is an amount of money offered to have said ad placed on said intranet and displayed to one or more users of said intranet; and
said external computer system sending said content of said ad, said parameter values and said bid to an internal computer system that is inside said intranet, wherein a result of said sending said content of said ad, said parameter values and said bid is a determination that said ad is permitted to be placed on said intranet, an identification of said one or more users of said intranet based on attributes of said one or more users matching said parameter values, and a placement of said ad on a page of said intranet based on said attributes matching said parameter values.

18. The method of claim 17, further comprising prior to said receiving said content of said ad, said external computer system receiving statistics from said internal computer system, wherein said statistics include counts of how many users of said plurality of users have said attributes, wherein said bid is based on said statistics.

19. The method of claim 17, further comprising:
said external computer system receiving metadata associated with said ad, said metadata received in said request from said publisher computer system to place said ad in said intranet, wherein said metadata includes one or more key words that describe said content of said ad; and
determining said ad is to be placed on said page based on said one or more key words matching one or more words that are included in said page or that describe contents of said page.

20. The method of claim 17, further comprising:
said external computer system periodically receiving analytic data from said internal computer system, wherein said analytic data includes a count of how many times a hyperlink in said ad is clicked and/or a count of how many impressions said ad has in pages of said intranet; and
said external computer system sending said analytic data to said publisher computer system.
